(19) United States
(12) Patent Application Publication
(10) Pub. No.: US 2024/0222971 A1
(43) Pub. Date: Jul. 4, 2024

(54) SYSTEMS AND METHODS FOR ELECTRIC VEHICLE CHARGING POWER DISTRIBUTION

(71) Applicant: Veloce Energy, Inc., Los Angeles, CA (US)

(72) Inventors: Jeffery D. WOLFE, Houston, TX (US); Michael SCHENCK, San Rafael, CA (US)

(21) Appl. No.: 18/503,724

(22) Filed: Nov. 7, 2023

Related U.S. Application Data
(63) Continuation of application No. PCT/US2022/029274, filed on May 13, 2022.
(60) Provisional application No. 63/188,828, filed on May 14, 2021.

(51) Int. Cl. H02J 3/00; B60L 53/302; B60L 53/63; B60L 53/67; G06Q 50/06; H02J 3/32

(52) U.S. Cl. CPC H02J 3/0075; B60L 53/302; B60L 53/63; B60L 53/67; G06Q 50/06; H02J 3/32

(57) ABSTRACT

Disclosed herein are systems and methods for power management in an EV charging site. A method may comprise sizing a plurality of electrical feeders. Once the feeders are sized, the site connects a plurality of energy storage systems to the plurality of electrical feeders. Then, the site connects a plurality of electrical loads to the plurality of energy storage systems and to the electrical feeders. Electrical loads of the plurality of electrical loads are interspersed with one or more energy storage systems of the plurality of energy storage systems. Next, for an electrical feeder of the plurality of electrical feeders, the site monitors a current flow at one or more points of connection of the electrical feeder to a load of the plurality of electrical loads. Then, the site provides power from the electrical feeder to the load while maintaining a current or a temperature at the electrical feeder to below a design limit.

### CROSS-REFERENCE

This application is a continuation of International Application No. PCT/US2022/029274, filed May 13, 2022, which claims the benefit of U.S. Application No. 63/188,828, filed May 14, 2021, each of which is incorporated by reference herein in its entirety.

### BACKGROUND

Power distribution systems can distribute power to many locations across a site. A site may have an electric vehicle (“EV”) charging site and multiple buildings. The EV charging site may have multiple EV charging stations with different use patterns. The buildings may have individual loads that have more predictable use patterns than the EV charging site. In some cases, a power distribution system distributes power in a large feeder that carries all the required power for the site to the first point of power use, where it is terminated at a main breaker that is sized to supply the entire site. Further power distribution may be from individual breakers at a main distribution panel (“MDP”). This method of power supply may make future expansion difficult, as new loads may need to be fed from the MDP, which may require expensive and difficult wiring runs. Adding new loads may also require a utility upgrade.

### SUMMARY

The present disclosure provides systems and methods for EV charging power distribution that may feature EV charging sites that are more efficient and less expensive than existing electric vehicle (“EV”) charging solutions. The EV charging site may flexibly adapt to changing power requirements by provisioning and de-provisioning battery energy storage systems (“BESSes”) or by adding or subtracting components within individual battery energy storage systems. Additionally, because battery energy storage systems may be operated as micro-peakers, the disclosed system may have a reduced-size main utility feed, as power may be injected into the site by adding battery energy storage systems as needed. The EV charging site may also be connected to a building power system that has zero spare or limited power capacity. The EV charging site can use spare power available off-peak to power the EV charging site resources while the rest of the systems in the building may be operating at full capacity. The EV charging site may also be more resilient to disruptions than existing EV charging sites. As each site may be operated as a microgrid of microgrids, outages in one microgrid may not result in outages in another.

The present disclosure also provides systems and methods that may comprise artificial intelligence (AI) processing tasks performed by the EV charging site to improve site efficiency. The EV charging site may collect data using sensors or other methods and use connected computing devices to process the data. The EV charging site may process the data using machine learning or artificial intelligence algorithms to produce actionable predictions which the site may use to control power flow to loads connected to the site. These predictions may enable the site to divide EV charging stations among microgrids to better prioritize charging, perform adaptive multimodal cooling on battery energy storage systems, optimize billing for charging services, deprovision degraded assets, and perform EV charging station scheduling and load balancing tasks.

The present disclosure also provides a method for re-establishing communications between a controlling entity of an EV charging site and site EV charging stations, in order for an EV station to be able to charge an electric vehicle if the station cannot access backend computing resources necessary for charging. A user device, after connecting to the EV charging station, can directly connect to the controlling entity over a network. Then, it may establish a link between the EV charging station and the controlling entity in order to enable the EV charging station to retrieve the instructions or resources it needs to be able to charge the user's electric vehicle.

The present disclosure also provides systems and methods that may comprise a process for providing emergency power from a charger to a vehicle of a first responder. The EV charging site may authenticate an emergency responder and then may provide the responder with emergency power. The process may override payment functions, enabling the responder to charge at reduced cost or for free. The process may idle other non-emergency local loads in order to free up charging resources for the emergency responder's electric vehicle. The disclosure also describes a process for connecting to emergency power infrastructure (e.g., generators) when additional emergency power is needed.

In an aspect, the present disclosure provides a method for power distribution at an electric (EV) charging site, wherein the EV charging site comprises a plurality of energy storage systems interspersed with a plurality of EV charging stations, wherein the EV charging stations and the energy storage systems are connected to a grid or other electrical power source by a plurality of electrical feeders. The method may comprise for an electrical feeder (herein interchangeably referred to as a “distribution feeder”) of the plurality of electrical feeders, monitoring a current flow at one or more points of connection of the electrical feeder to an electrical load of the plurality of electrical loads; if the current is above a design limit, stopping a flow of current to the electrical load and providing current from an energy storage system; and if the current is below the design limit, maintaining the flow of current to the electrical load and charging one or more of the plurality of energy storage systems. In some embodiments, stopping the flow of current to the electrical load comprises sending a signal to a breaker. In some embodiments, the energy storage system is a battery energy storage system. In some embodiments, maintaining the flow of current comprises automatic reconfiguring of the current flow paths using a trained machine learning algorithm. In some embodiments, the machine learning algorithm determines when to configure charging and discharging of the energy storage system. In some embodiments, the monitoring the current flow is performed continuously. In some embodiments, a point of connection of the one or more points of connection is next to a meter or next to a transformer. In some embodiments, the method further comprises connecting one or more additional energy storage systems when one or more requirements of the plurality of electrical loads changes. In some embodiments, the plurality of energy storage systems is connected using a mesh network. In some embodiments, the plurality of energy storage systems is controllable as a single unit. In some embodiments, the plurality of energy storage systems includes one or more energy storage systems that are individually controllable.

In another aspect, the present disclosure provides a method for selecting an EV charging station of a plurality of EV charging stations at an EV charging site. The method may comprise obtaining one or more parameters of each of the plurality of electric vehicle charges, wherein the one or more parameters comprise one or more of an efficiency, a temperature, and a voltage drop; computer processing the one or more parameters to determine a usage schedule for the plurality of electric vehicle chargers at the electric vehicle charging site; and selecting an EV charging station for use by a user, based on the usage schedule. In some embodiments, the method further comprises indicating the selected EV charging station to the user. In some embodiments, the indicating is provided using an onsite announcement or through an electronic display. In some embodiments, the onsite announcement is visual or audible. In some embodiments, the electronic display is a user device. In some embodiments, the indicating is performed using a mobile application. In some embodiments, the one or more parameters further comprise advertising information and user information obtained from the user device. In some embodiments, determining the usage schedule further comprises computer processing degradation data, economic data, proximity data, or user data. In some embodiments, degradation data comprises or corresponds to a presence of elevated temperature, efficiency loss, or unexpected changes in fan speed, fan operation time, fan pressure, voltage, current draw, or energy delivered by an energy storage system. In some embodiments, economic data is buying patterns, charging rates, or user purchase behavior. In some embodiments, proximity data is closeness to retail entities, weather data, natural disaster data, or location safety data. In some embodiments, user data is parking priority data, vehicle type, or vehicle use.

In another aspect, the present disclosure provides a method for performing predictive cooling of an energy storage unit. The method may comprise implementing a calibration routine to determine a plurality of operating states of an energy storage system; determining a usage profile of the energy storage system; and initiating multimodal cooling of the energy storage system based on the calibration routine and the usage profile, wherein the multimodal cooling comprises at least two of air cooling, heat pipe cooling, and economizer cooling, based on the usage profile and the calibration routine. In some embodiments, the usage profile includes heavy usage periods and low usage periods. In some embodiments, multimodal cooling further comprises lowering a temperature of the energy storage system during heavy usage periods and raising a temperature of the energy storage system during low usage periods. In some embodiments, the plurality of operating states includes a peak temperature, an average temperature, and a lifetime average temperature. In some embodiments, the calibration routine uses a trained machine learning algorithm to determine the plurality of operating states, wherein the trained machine learning algorithm processes one or more of heat dissipation data, impedance data, age data, or external temperature data.

In another aspect, the present disclosure provides a system for displaying information to a user of an EV charging station, comprising: one or more sensors for collecting data about the user, the EV charging station, an electric vehicle of the user, or an EV charging site comprising the EV charging station; one or more computing devices for processing the information to generate a signal; and an audiovisual signaling device for transmitting the signal to the user, wherein the audiovisual signaling device is disposed on a portion of the EV charging station or the EV charging site. In some embodiments, the audiovisual signaling devices display a charging status of the vehicle, an availability of the charging asset, a cost, a parking location, or service requirements for a vehicle, or the state of charge of the vehicle. In some embodiments, the audiovisual signaling devices are lights, speakers, alarms, flags, signs, moving graphics, electronic screens, or other visual or auditory signals. In some embodiments, the audiovisual signaling devices are installed on an overhead structure, busway, vertical structure, charging stand, independent support, battery system enclosure, or other apparatus. In some embodiments, the audiovisual signaling devices project color, pattern, written messages, moving graphics, auditory signals upon a parking space/driveway or near or adjacent to a parking space or charging stall.

In another aspect, the present disclosure provides a method for providing a user emergency access to an electric vehicle (EV) charging station. The method may comprise (a) receiving a request from the user to access the EV charging station; (b) determining that the request is valid; (c) in response to (b), providing the user access to the EV charging station; and (d) locally idling one or more loads, wherein the one or more loads are not a vehicle of the user. In some embodiments, the method further comprises increasing a charging rate of the vehicle of the user. In some embodiments, the method further comprises transmitting one or more emergency operating conditions related to the access of the vehicle to the charging station to a network-connected location. In some embodiments, the method further comprises disabling a payment function of the vehicle charging station. In some embodiments, the method further comprises overriding a power limit of the vehicle charging station. In some embodiments, the request comprises a radio frequency identification (RFID) signal, a security code, or an electronic key.

In another aspect, the present disclosure provides a method for reestablishing a dropped communication between an EV charging station and a remote server. The method may comprise establishing a first communication link between the EV charging station and a mobile device of a user or an electric vehicle, establishing a second communication link between the mobile device or the electric vehicle and the remote server; using the first communication link and the second communication link, re-establishing the dropped connection between the electric vehicle charger and the remote server; and monitoring the re-established connection for faults or failures. In some embodiments, the first communication link is a Bluetooth, MESH, or Wi-Fi link. In some embodiments, the second communication link is a cellular or satellite link.

In another aspect, the present disclosure provides a method of re-establishing a link between an EV charging station and an electric vehicle. The method may comprise (a) cycling commands from a controlling entity to the EV charging station; (b) cycling communications power to the EV charging station and (c) rebooting the EV charging station. In some embodiments, the method further comprises locally buffering data for communication between the electric vehicle and the EV charging station.

In another aspect, the present disclosure provides a method for regulating a supply of power from one or more EV charging stations at an EV charging site. The method may comprise obtaining data regarding demand for power at the EV charging site; processing the data to determine changes in power supply for the one or more EV charging stations; and prompting at least one of the one or more EV charging stations to perform an action, responsive to the changes in power supply. In some embodiments, the data is a utility tariff, a demand charge, a total site demand, an existence of one or more demand events, and a condition of an energy storage system. In some embodiments, the action is reducing a cost to charge the electric vehicle, increasing a cost to charge the electric vehicle, or providing an offer to a user of the electric vehicle.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates an electric vehicle (EV) charging site;

FIG. 2 schematically illustrates a subsystem for controlling the current draw of electrical loads in the EV charging site of FIG. 1;

FIG. 3 is a flow chart of a process for connecting battery energy storage systems (BESSes);

FIG. 4 is a flow chart of a process for automatically reconfiguring electric power delivery using artificial intelligence;

FIG. 5 is a flow chart of a process for handling communications between an EV charging station and an electric vehicle in the event of communication failure;

FIG. 6 is a flow chart of a process for adaptively cooling a battery energy storage system by performing machine learning analysis on data collected from the BESS and the EV charging site;

FIG. 7 is a flow chart of a process for providing emergency power from a charger to a vehicle of a first responder;

FIG. 8 is a flow chart of a process for connecting emergency infrastructure in an event additional power is needed;

FIG. 9 is a flow chart of a process for de-provisioning degraded EV charging site assets; and

FIG. 10 schematically illustrates a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The disclosed method of power distribution for an electric vehicle (“EV”) charging site may enable less expensive and more efficient operation of onsite EV charging stations. To achieve this efficiency, the disclosed EV charging site may be able to operate its EV chargers at a connection carrying much less than 100% of the site's maximum load. Such a connection may be significantly smaller than those at other EV charging sites The site may achieve this result by leveraging distributed energy sources (e.g., battery energy storage systems (“BESSes”)) installed throughout the site. A main utility feed may run across the entire site at a uniform size, enabling supply of 100% of the utility power across the entire site. The systems and methods disclosed herein may be implemented for (1) DC EV distribution systems, use cases, and applications and/or (2) AC EV distribution systems, use cases, and applications. The systems and methods disclosed herein may be implemented for both DC and AC EV distribution systems, use cases, and applications.

The EV charging site may operate in accordance with the following principles: (1) power flow through the main feeder may be actively limited to the legal feeder capacity; (2) power may be discharged from local battery energy storage systems to meet any loads above the capability of the feeder or utility connection; (3) power may be discharged from local battery energy storage systems to serve non-local loads at other locations on the site; (4) battery energy storage systems (BESSes) may be recharged whenever there is spare power capacity in the main feeder; and (5) power may be made available from other sources on the site, including solar PV, DER, generators, etc. In some cases, the EV charging site may be controlled according to a load schedule. Power distribution in the EV charging site may be regulated during times of heavy demand or during a limitation associated with a curtailment event due to natural disaster or due to public safety power shutoff (PSPS, or other power disruption) causing an overall power reduction. The system may use information regarding feeder size and information from thermal sensors to determine a level of increase of an amount of current flowing in the feeder to the local load.

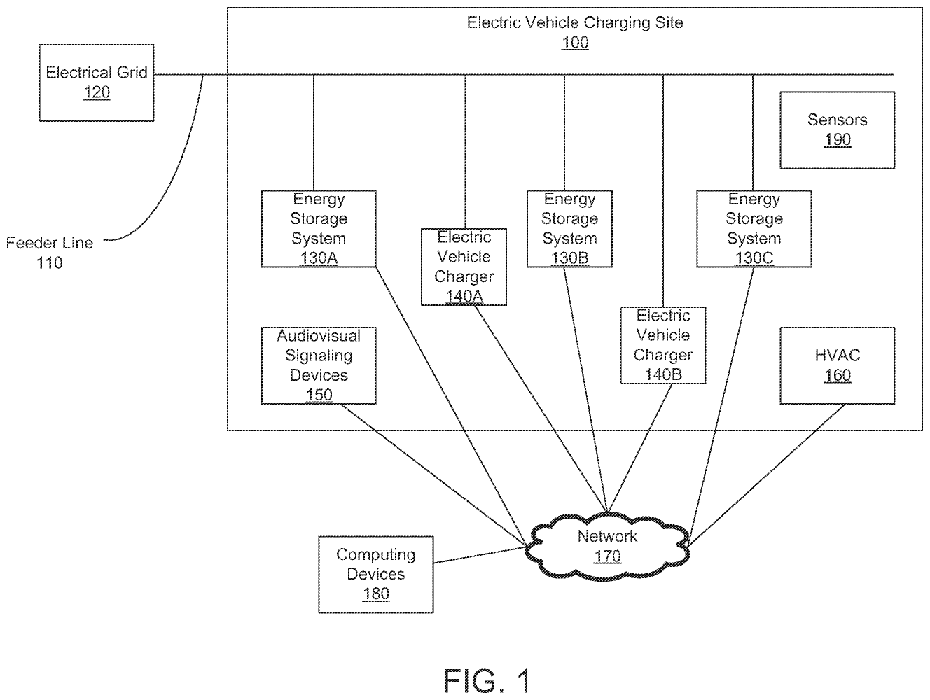

FIG. 1 illustrates an electric vehicle (“EV”) charging site 100. The EV charging site 100 may be connected to an electrical grid 120. Transmission and/or distribution lines may route power from a generating source to the EV charging site 100. A transformer may step down the voltage from the transmission and/or distribution line to make the voltage level suitable for delivery to EV charging stations or other charging site endpoints (e.g., battery or other energy storage systems, computing devices, lighting, heating, ventilation, and cooling units (HVAC), audiovisual signaling devices, or other endpoints). The EV charging site 100 may deliver alternating current (AC) or direct current (DC) power. The EV charging site may use switchboards or panelboards to facilitate distribution of electrical power. The EV charging site 100 may contain a feeder line 110, EV charging stations 140A-B, computing devices 180, a network 170, sensors 190, audiovisual signaling devices 150, battery energy storage systems 130, and HVAC 160.

The feeder line 110 may transmit power from the transformer to the EV charging stations and to other electrical components within the EV charging site 100.

The EV charging stations 140A and 140B charge the batteries of electric vehicles by supplying them with power from the power grid or one or more other power sources. The EV charging station 140 may be an overnight charger or a high-speed charger. The EV charging station 140 may be a receptacle into which the electric vehicle may plug into, or it may be a wireless charger. The EV charging station 140 may use Level 1, Level 2, Level 3 charging, or a type of charging with a higher power level than Level 3 or a lower power level than Level 1. As used herein, Level 2 charging may comprise charging between about 6 amps and about 80 amps at about 208 volts or 240 volts (i.e., between 1.4 and 19.2 kilowatts of power). As used herein, Level 1 charging may comprise charging at a power level that is lower than the power level for Level 2 charging, in some cases using AC power input to the vehicle. Level 3 charging may comprise charging at a power level of 24 kW or higher, in some cases with DC input to the vehicle. The EV charging station 140 may be connected to an alternating current (AC) or direct current (DC) power supply.

An EV charging station 140 may be at a public charging station, accessible to all. The EV charging site may limit access to EV chargers to particular subscribing users, who may be able to access charging services from the EV charging stations at reduced prices, or who may be guaranteed access to charging during times of high site demand.

An EV charging station may be configured to provide communications when connected to an electric vehicle that is not charging. In this circumstance, an EV charging site controller (e.g., human or computer) may command the charger to supply a small amount of power as a continuous “power signal” to keep vehicle-charger communications open. The small-power signal may be considered an “Available but limited” signal. The communication may override a signal from a Charge Network Operator (CNO) (i.e., an entity controlling an EV charging station or a group of EV charging stations) indicating that the vehicle should be charged. Communication with the electric vehicle may provide the controller with information including the charging state of the vehicle battery, the desired time for full charge, and other desired outcomes (e.g., vehicle-to-grid (V2G), vehicle-to-building (V2B)) In examples of desired outcomes, power may flow from the vehicle to any other device or system on the EV charging site 100 or back into the electrical grid 120.

The computing devices 180, either onsite or remote, may collect site data and perform artificial intelligence (“AI”) processing. The computing devices 180 may be desktop computers, mainframe computers, laptop computers, tablets, smartphones, personal digital assistants (PDA), or other mobile computing devices. The computing devices 180 may be connected to other charging site electronics via the network 170. The computing devices 180 may include client devices for configuring AI tasks, remote or onsite monitoring of EV charging stations or other devices, or for controlling site operations. The computing devices 180 may also include server devices for performing artificial intelligence or machine learning tasks, for performing other processing tasks on site data (e.g., compression, de-noising, dimensionality reduction, or data cleanup), or for storing site data collected from the sensors. Computing devices 180 may calculate the diversity value of the EV charging site and perform load scheduling.

The computing devices 180 can use artificial intelligence (AI) to determine billing rates for vehicle charging to flexibly change charging costs in different scenarios. AI algorithms may take as input, for example, time connected to an EV charging station 140 or a battery energy storage system 130, power consumed by the vehicle, a state of charge or a condition of the battery energy storage system 130, utility rates, total site demand, type of vehicle, membership in a site program, and presence of an emergency. AI algorithms may predict a preferred charging cost, based on these inputs, to maximize earnings or another parameter (e.g., system component operational parameters including device status, device lifecycle cost, device duty cycle, etc) in view of the EV charging site's operating parameters. The EV charging site 100 may use the computing devices 180 to determine how to set prices to charge electric vehicles and prompt the EV charging stations to raise and lower charging costs based on these determinations. The AI system may be used to determine an offer to present to drivers using one or more of the audiovisual signaling devices 150. Alternatively, a Charging Network Operator (CNO) or a Site Equipment Operator (SEO) may manually determine prices for EV charging. Payment levels may be configured to increase efficiency, increase revenue, minimize costs to recharge batteries, increase availability of charging resources during adverse or emergency situations, prevent degradation of assets, or provide social benefits.

The computing devices 180 may be able to set costs at multiple EV charging sites. Costs at one site may be configured to differ for charging different vehicles at the site, depending on factors such as network membership (e.g., premier, preferred, or other), differentiated membership, vehicle manufacturer, make, or model, and whether the vehicle is an authorized emergency response vehicle. Costs may be determined algorithmically (e.g., using machine learning algorithms).

The network 170 may connect the EV charging stations to the computing devices 180. The network 170 may be a LAN, MAN, WAN, or MESH network 170. Use of a MESH network may enable the EV charging stations to be controlled as a single operational system. The EV charging stations 140, using a MESH network, may be able to communicate with and exchange information with one another. Thus, the EV charging stations may be able to cooperate with one another in order to perform scheduling, load balancing, or steering tasks. The MESH network may be a fully connected network, with all endpoints (e.g., battery energy storage systems 130 and EV charging devices 140) in the EV charging site 100 being able to communicate with one another. When BESSes are installed without an associated EV charging site, they may be able to provide similar scheduling, load balancing, and steering services to an individual power distribution circuit, a substation, a utility, or a regional or interstate grid operator. These services can be provided from a single BESS or by any number of BESSes operating in any configuration, with or without associated EV charging sites. BESSes can also be used to reconfigure and control a distribution feeder by injecting any of voltage, amperage, volt-amps, reactive power with the purpose of changing the operation of the distribution circuit or a portion of it.

The sensors 190 may collect EV charging site data for use by computing devices 180 for artificial intelligence processing or for other purposes. The sensors may be thermometers, multimeters, voltmeters, ammeters, accelerometers, pressure sensors, radar sensors, microphones, cameras (including RGB and infrared cameras), or other sensors. The sensors 190 may collect temperature data, energy data, fan speed/operation/pressure, voltage, and current data.

In an AI-based system that is code compliant, the sizing of a conductor, including of a tap conductor, is limited to just the maximum current carrying capacity (per specific code guidelines) at a given temperature or installation condition (i.e., as within a conduit or raceway or environmental condition). Measurements may occur via directly sensed items or via indirect means (e.g., calculation, outside information source, inference, etc.) as determined by the AI algorithm. The conductor must be sized to the delivered load or set of loads, or set of loads following a demand factor, typically at its maximum consumption rating, and this may result in over sizing of the feeder, tap conductor, or other conductor supplying current to the system. A dynamically configurable system with sufficient metering (current sensor) at each node to permit load current calculations to be performed, may allow a load management system (or EMS) to dynamically limit the available power (current) flow on a conductor; as limited by series connected and dynamically configured OCP (Over Current Protection) devices. This permits the conductor to be sized for optimal economic or site conditions, environmental (ambient temperature) instead of total load capacity. Various distributed energy resources management system (DERMS) or BESS maybe connected at any point along the system and managed via dynamic dispatch from the load management system (LMS) or energy management system (EMS) or system protection or relay controller; additionally, current that may be flowing into a fault, short, malfunctioning device, etc. may easily be detected by the site EMS/LMS system.

The computing devices 180 may perform various artificial intelligence processing tasks. AI processing tasks can configure charging and discharging of the battery energy storage systems 130, optimize scheduling, direct onsite announcements, steer users towards particular EV charging stations, and direct heating and cooling. The EV charging site 100 may use AI algorithms to microgrid the distribution system. For example, a partitioning algorithm may divide multiple sites into microgrids, or an individual site into microgrids, by determining settings for site electrical components, such as switches, switchboards, and panelboards. The EV charging site may use such an algorithm to control groups of chargers or charging resources separately. For example, one group of resources may be optimized to power compact or small vehicles, while another group may be optimized to power larger vehicles or commercial vehicles. One group of resources in one site location (e.g., EV charging stations and battery storage energy systems) may be optimized to accommodate higher volumes of customers than another in a different site location. Further, groups of resources may be configured to accommodate different types of customers based on customer data. AI algorithms may also be able to analyze load demand and determine whether to provision additional energy storage systems.

The AI algorithms may be machine learning algorithms to process site data. Machine learning algorithms may include supervised and unsupervised machine learning algorithms. Unsupervised machine learning algorithms may include clustering algorithms (e.g., K-means clustering). Supervised machine learning algorithms may include neural networks (e.g., convolutional neural networks and recurrent neural networks).

The audiovisual signaling devices 150 may be lights, speakers, alarms, flags, signs, moving graphics, electronic screens, or other visual or auditory signals. The audiovisual signaling devices 150 may be installed on an overhead structure, busway, vertical structure, charging stand, independent support, battery system enclosure, or other apparatus. The audiovisual signaling devices 150 may project colors, patterns, written messages, moving graphics, or auditory signals upon a parking space/driveway or near/adjacent to a parking space/charging stall. The audiovisual signaling devices 150 may indicate charging station status or rates or display advertisements. The audiovisual signaling devices 150 may be used to steer users to particular EV charging stations. The audiovisual signaling devices 150 may provide commercial workers or drivers with indications of orders to be filled, package locations, materials to be loaded or unloaded, loading statuses of vehicles, loading queue information, statuses of luggage or items to be loaded, or service requirements for particular vehicles. The audiovisual signaling devices 150 may also indicate the current status of the electrical grid 120, the states of the EV charging stations, the states of the battery energy storage systems, current costs of charging, availability of chargers, and statuses of equipment health. Additionally, the audiovisual signaling devices 150 may display emergency information, weather information, or other useful information.

The audiovisual signaling devices 150 may display advertisements to drivers or passengers of electric vehicles. The EV charging site may collect data from drivers of electric vehicles using the site's EV charging stations, from sensors, by connecting to user mobile devices, or from user-submitted information (e.g., information provided by a user in the course of check-in or payment). Vehicles may also be identified by cameras identifying license plates numbers or other identifying information, by radio frequency identifier (RFID) tags, similar to those used for toll collection or through manufacturer-provided identification provided through the EV charging plug. The information may be vehicle information, such as the make, model, or color of the user's EV. The information may be personal information, such as user site visit frequency, charger use, user-submitted personal information (name, age, gender, etc.), and user-submitted reasons for charging at the site (e.g., cheapest, closest to home, closest to local attractions). The information may be site information, such as the location of the EV charging site or the weather outside the EV charging site. The EV charging site may process the data with a machine learning algorithm using the computing devices 180. The algorithm may be configured to select a targeted advertisement for display to the user, e.g., at a user interface of the EV charging station, on an overhead display, or through a speaker. The targeted advertisement may be selected from a group of candidate advertisements based on a prediction made by the machine learning model. For example, the candidate advertisements may include advertisements for stores or attractions near the EV charging site. The selected advertisement may be for an attraction the user is most likely to visit, based on the prediction by the machine learning algorithm.

The battery energy storage systems (BESSes) 130 may receive electrical energy and store it for use at a later time or date to supply to an electric vehicle for charging. A battery energy storage system 130 may use lithium-ion, lead-acid, sodium sulfur, or zinc bromine technology. The battery energy storage system 130 may supply electric power at moments when an EV charging station 140 may not be able to supply power (e.g., when the EV charging station is drawing too much grid power). The energy storage system 130 may additionally be a pumped hydro, compressed air storage, or mechanical flywheel storage system. The EV charging site 100 may store energy in a battery energy storage system 130 to reduce peak demand for electricity Battery energy storage systems 130 may be added to or removed from the site at any time.

A battery energy storage system 130 may contain an integrated controller. The energy storage system and controller complex may connect to the network 170 and receive instructions from site operators using the computing devices 180. The integrated controller may determine a rate of charge for the energy storage system to provide to an EV charging station. The integrated controller may also capture information about the battery energy storage system 130 and provide it to other network components. The site may keep data as to whether the charger is degrading, malfunctioning, or acting in a way indicative of pending failure (predictive maintenance), its current mode or status of operation, and whether it is currently engaged in charging an electric vehicle, for example. In other embodiments, the EV charging site 100 may include standalone controllers (e.g., at the computing devices 180) which control the electric vehicle charging devices remotely.

The heating, ventilation, and cooling system (HVAC) 160 may maintain optimal or preferred operating temperatures for electrical charging site equipment. The HVAC 160 may be manually controlled or digitally controlled. HVAC 160 can be controlled individually, or across an entire site. Control can include predictive AI elements. The HVAC 160 system may include heaters, air conditioners, refrigeration equipment, vents, fans, water cooling devices, pumps, ducts, or other heating, cooling, and ventilation equipment. The EV charging site 100 may use multi-modal cooling, including simultaneously using at least two of heat pipe cooling, air cooling, and economizer cooling.

In order to regulate the temperature of the battery energy storage system 130, the battery energy storage system 130 may be enclosed in a cabinet with ducting run along the top, sides, bottom, or door. The HVAC system may be designed to maintain optimal temperature at each battery module through use of specially tuned or shaped ducting, variable speed airflow, sensors at battery modules, variable speed control of HVAC or individual battery module fans, or other means. The HVAC 160 may circulate air within the cabinet in order to heat or cool it. The cabinet may include additional external features, including fins, paint, solar shielding, thermal mass, or other devices, to achieve a desired heat transfer. For example, in environments where solar loading is low and ambient temperature is also low, a duct may be opened, increasing radiated heat expelled from the cabinet. The cabinet may also be used to regulate the humidity and condensation of the energy storage system. Ducting may be open or closed using a mechanical, electromechanical, or temperature sensitive actuator. A cooling fan may be used to augment cooling of the energy storage system. The ducting may be dynamically controlled to augment internal convective airflow currents within the enclosure. The size of the ducting can be as small as half an inch. Radiant insulation may be used to augment the cooling or heating effectiveness of the ducting. Where the path of the airflow used for heating, cooling, or humidity control is constrained, either by ducting, cabinet configuration, or equipment configuration, a portion of the material constraining the airflow path may also be used as relief venting, whereby a portion may automatically open whenever internal pressure rises above ambient pressure, such as in an internal thermal event, deflagration, or explosion. Operation may be reversible (reclosing automatically after the pressure is released) or not, may involve electric or non-electric sensors and actuators, or may not.

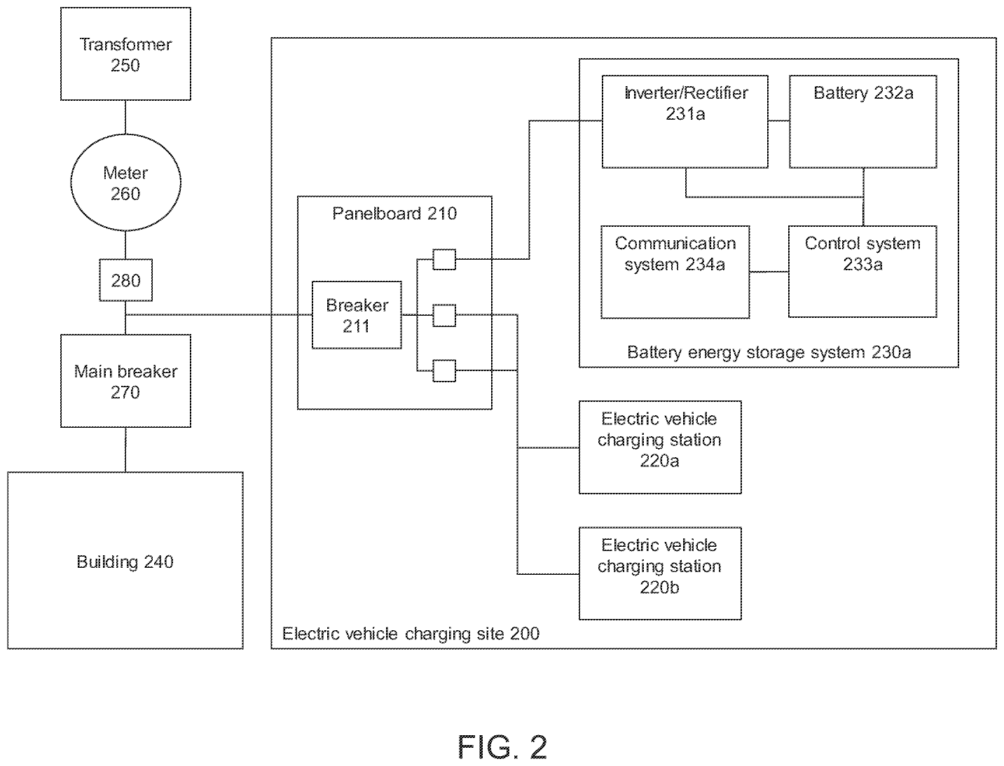

FIG. 2 schematically illustrates an EV charging site 200, according to some embodiments of the present disclosure. The EV charging site 200 may have a panelboard 210, one or more EV charging stations 220, and one or more battery energy storage systems 230. The panelboard 210 may have a circuit breaker 211. The circuit breaker 211 can protect downstream components (e.g., the EV charging stations 220) from overload conditions and short circuits. The circuit breaker 211 may have a sensor for detecting such overload conditions and short circuits. The circuit breaker 211 may also have an actuator mechanism for separating the contacts of the circuit breaker 211 when the sensor detects an overload condition or short circuit. The panelboard 210 may also have one or more relays (e.g., one relay for each EV charging station 220 or battery energy storage system 230 in the EV charging site 200).

The circuit breaker 211 or other over current device (fuse, contactor) may be located in the panelboard, or it may be located closer to the EV charger, BESS, or building, connected to an above ground electrical distribution system. A full-size power distribution system may be installed across the site. Individual power connections may be made wherever needed. Each connection can have a system on it which may embody any of the above functionality (over current protection, remote actuation, incorporation of relays for any purpose, annunciation, power quality monitoring). The use of point of use metering and current sensors may augment the use of power flow management and switch controls. Further, the point of use metering also may provide indications of power flow and may be used in compensation mechanisms; such mechanisms may be local or remote and used at other sites.

The EV charging stations 220 may be EV charging stations. The EV charging stations 220 may have power electronics, controllers, connectors, and communication devices. The power electronics may include transformers, inverters, voltage regulators, sensors, and the like. The EV charging stations 220 can supply alternating current (“AC”) power. The AC power may be single phase or three phase power. In some cases, the EV charging stations 220 supply between 6 amps and 80 amps of power at about 208 volts or 240 volts (i.e., between 1.4 and 19.2 kilowatts of power) (AC Level 2). Alternatively or additionally, the EV charging stations 220 can supply direct current (“DC”) power by rectifying AC power from the grid. In some cases, the EV charging stations 220 supply up to 80 kilowatts of power at 50-2000 volts (DC Level 1). In other cases, the EV charging stations 220 supply up to 400 kilowatts or 1500 kilowatts of power at 50-2000 volts.

The controllers can control the rate of charge of EVs that use the EV charging stations 220. The controllers can also control access to the EV charging stations 220. For example, the controllers can authenticate access requests from EVs or other sources (e.g., driver's mobile devices). The controllers can also implement payment functionality (e.g., credit card processing). The controllers can also provide control signals to the EVs via the connectors. The control signals may contain data about the charging process. The controllers can also process signals sent by the EVs regarding the charging process. The connectors can facilitate connection between the EV charging stations 220 and the EVs. The connectors may have power pins and control signal pins. The communication devices can enable the EV charging stations 220 to communicate data and control signals to remotely located devices (e.g., other EV charging stations, battery energy storage systems 230, and remote servers) over a wired or wireless network.

The battery energy storage systems (BESSes) 230 may be interspersed with the EV charging stations 220. Each battery energy storage system 230 may have an inverter/rectifier 231, a battery 232, a control system 233, and a communication system 234. The inverter/rectifier 231 can convert AC power from the grid to DC power for the battery 232, or it can convert DC from the battery 232 to AC. The inverter/rectifier 231 may have a DC-DC converter. The DC-DC converter can increase or decrease the voltage of the DC supplied by or provided to the battery 232. The BESS may also be a DC source equipped with a DC-DC converter or a DC-DC converter function or directly couple the batteries to the system bus.

The battery 232 can store energy. The battery 232 can be charged during off-peak times (e.g., when demand is less than a maximum threshold). The battery 232 can be discharged for use by the EV charging stations 220 or the building 240 at any time. The battery 232 may have one or more electrochemical cells. The chemistry of the one or more electrochemical cells may be lithium-ion, lithium-polymer, sodium-sulfur, lead-acid, nickel-cadmium, or the like.

The control system 233 can control the operation of the inverter/rectifier 231 and the battery 232. For example, the control system 233 can increase or decrease the amount of current supplied to the inverter/rectifier 231 or the rate of discharge of the battery 232. The control system 233 can control these parameters by transmitting control signals to various electronic components in the battery energy storage system 230, including relays, transistors, and the like. The control system 233 may have one or more computers that are programmed to implement a control algorithm to determine the control signals. The control algorithm may be a machine learning algorithm or AI algorithm. The machine learning algorithm may be trained to implement predictive control of the battery energy storage system 230, forecast available power and loads, or optimize the battery energy storage system for cost, battery cycles, reliability, or emergency response.

The communication system 234 can communicate with other electronic devices both internal and external to the EV charging site 200 through wired or wireless networks. For example, the communication system 234 can communicate with the current relay 280 as described in greater detail below.

The EV charging site 200 may be associated with a building 240 (e.g., an apartment complex, a grocery store, shopping mall, or the like). A transformer 250 can supply grid power to the building 240 and the EV charging site 200. The building 240 may have a meter 260 and a main breaker 270. The meter 260 can determine the amount of power used by the building 240 and the EV charging site 200, and the main breaker 270 can prevent the building 240 from exceeding current limits. The sum of the capacity of the main breaker 270 and the circuit breaker 211 may be larger than the capacity of the transformer 250 due to the battery energy storage systems 220. This may allow the grid connection to be smaller than normal, reducing costs. The EV charging site 200 may be connected to grid power either before the main breaker 270 (e.g., as depicted in FIG. 1) or after the main breaker 270, depending on the local electrical code. In some cases (e.g., when the EV charging site 200 is connected to grid power before the main breaker 270), the EV charging site 200 may have a separate electrical meter. A current relay 280 may be disposed after the meter 260 (e.g., as depicted in FIG. 1), or before the meter 260 but after the transformer 250. The current relay 280 can detect the total current drawn by the EV charging site 200 and the building 240. Additional current relays may be disposed at the electrical connection to any or all BESSes 230.

The current relay 280 can transmit a signal to the communication system 234 of the battery energy storage system 230. The signal may specify the total current drawn by the EV charging site 200, the building 240, and each BESS 230. The current relay 280 may transmit the signal on a continuous or period basis. For example, the current relay 280 can transmit the signal about every microsecond, millisecond, second, 10 seconds, 1 minute, or more. The communication system 234 can then transmit the signal to the control system 233. The control system 233 can process the signal with a control algorithm to maintain the current at or below the capacity of the transformer 250. The output of the control algorithm may be a control signal may cause the inverter/rectifier 231 to increase the current that it draws from the grid (i.e., if the transformer 250 has additional capacity), decrease the current that it draws from the grid (i.e., if the transformer has little or no additional capacity), and/or increase or decrease the current provided by the battery 232. Current relay actions may also depend on whether the BESSes are permitted to feed power backwards through the transformer, and at what level of power they are allowed to feed backwards, or may also depend on power quality operations. The current relay 280 can also transmit signals to the EV charging stations 220. The signals may cause the EV charging stations 220 to increase or decrease their current draw. The current relay 280 can also transmit a signal to the circuit breaker 211. The signal may cause the circuit breaker 211 to trip in the case of an overload or short circuit. In some cases, a power or temperature sensor can be used in place of or in addition to the current relay 280.

The EV charging site 200 described in FIG. 2 provides numerous advantages. First, it can be connected to a building power system that has no spare power capacity at peak because it can utilize spare power available during off-peak times. Second, it can accommodate changes to the building power system through the addition or subtraction of battery energy storage systems or through the addition or subtraction of batteries in a particular battery energy storage system. Third, it can have a smaller and less expensive connection to grid power than traditional EV charging sites because the battery energy storage systems can provide power during peak demand. Fourth, it may be more resilient than traditional EV charging sites that rely solely on grid power. Additionally, the EV charging site may be capable of acting in a microgrid context, restarting the charging process, enabling cloud or cellular communications, lighting, and other loads during a shut down.

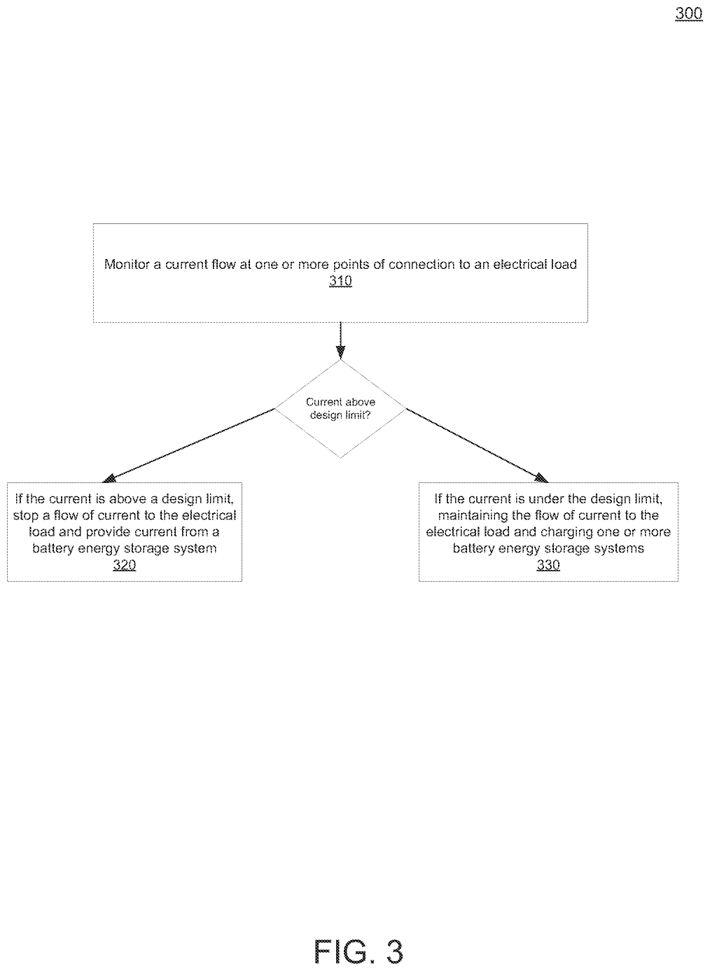

FIG. 3 is a flow chart of a process 300 for powering EV charging site loads, according to some embodiments of the present disclosure. Prior to powering the loads, the EV charging site may schedule the loads based on a diversity factor. The EV charging site may calculate the diversity factor as the sum of the maximum loads of individual site components divided by the maximum load of the EV charging site. The maximum load of the site may be less than the sum of the individual loads. This may be because all loads are not operating simultaneously, or because site components may be damaged or may not operate with preferred economic levels if all components are operating simultaneously, or because the loads are commanded to operate at lower power levels.

The EV charging site may size connections of the loads to the power source such that the power source provides less than 100% of the maximum site load. For example, the feeders may only carry 50% of the maximum load. The sizing may be selected to be far below the maximum operating capacity of the EV charging site, enabling the site to save utility connection and construction costs as well as energy costs overall. The EV charging site may optionally maintain uniform sizing of the feeder line for the entire length of the site to allow simple capacity additions at the end of the feeder line and promote bidirectional power flow across the entire system. The EV charging site may maintain multiple energy storage systems (e.g., battery energy storage systems (BESSes)), interspersed with the loads.

The EV charging site may use the power from the electrical grid or service connection to power loads up to the limit of the connection. In excess of the grid connection capacity, the energy storage systems can supply power to the EV charging site. If site loads drop below the electrical connection capacity, the system can charge the battery energy storage systems. Alternatively, the battery energy storage system may be charged according to a schedule. Battery energy storage systems may be added or subtracted at any time to meet changing load profiles. Further, either power conversion (kW), or energy storage (kWh) systems may be added independent of each other, or at the same time.

In a first operation of the process 300, the EV charging site monitors the current flow and voltage in the feeder cables or busses at points of connection of electrical loads, including the EV charging stations (310). The EV charging site can monitor current and voltage continuously or take measurements periodically, e.g., every millisecond, every half-second, every second, every 10 seconds, every 20 seconds, every 30 seconds, every minute, every five minutes, every 10 minutes, every 20 minutes, every 30 minutes, every hour, every two hours, every three hours, every six hours, every 12 hours, or every day. The EV charging site may operate the energy storage system as required to maintain a current, voltage, power factor and temperature within a feeder to below a design limit. If the current is above a design limit, the EV charging site stops (Operation 320) a flow of current to an electrical load (e.g., the EV charging station) and provides current to the load from the battery energy storage system. If the current is under the design limit (Operation 330), the EV charging site may maintain a flow of current to the electrical load and charges one or more battery energy storage systems. Voltage may be controlled to modify the normal voltage from the utility grid to have different characteristics which may be more favorable for operation of connected devices. The use of volt-ampere reactives (VARs) and other harmonic elements may be used to alter the power factor, frequency, waveform shape or waveform to maximize charge energy transfer from the utility to the chargers. Additionally, an arbitrary electrical waveform can be modified by injection to also provide more favorable operation of connected devices including EV chargers.

For DC systems, the EV charging site may create an electrical network with energy flows in multiple directions and with multiple feeds converging on one or more points, as well as creating a complete loop around the site.

For AC systems, the EV charging site may create a loop with multiple automatic or manual loop-break switches which can be used to move a break point to a preferred location around the site. This can be accomplished while the site is operating, since instantaneous loads can be carried by the energy storage systems to allow momentary isolation of any segment of the loop. This isolation or segmentation may occur due to fault or momentary overloading of a given segment.

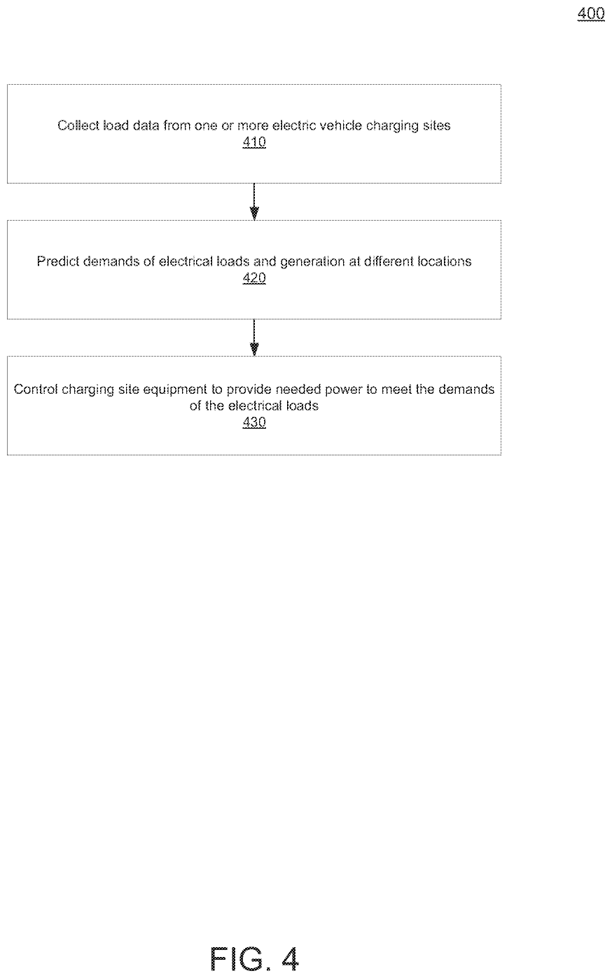

FIG. 4 is a flow chart of a process for automatically reconfiguring electric power delivery using artificial intelligence. Reconfiguration of power delivery may be performed in order to reduce degradation of physical equipment, to provide economic benefits (e.g., steering users to points interest), for advertisement purposes, or to account for local grid conditions (e.g. peak demand, low demand, outage, excess distributed generation), provide ancillary services or weather conditions. Users may be steered to particular EV charging stations using onsite signaling by the audiovisual devices or via increasing costs to charge at particular charging stations. The site may steer users towards EV charging stations that are in good working condition. Reconfiguration may be performed at one or more charging sites using a common set of computing devices.

In a first operation 410, one or more EV charging sites provide charging data from EV charging stations or direct measurement devices located at the sites to computing devices for analysis. Data may include information about the degradation of site assets. Degradation information may include any information indicative of performance losses, including elevated temperatures, increased fan speeds, and losses in energy delivered to electric vehicles. Degradation information may be collected directly from sensors, indirectly over a network, or from indicators such as electrical signatures, voltage excitation conditions, calculated asset loads, temperature readings, capacitance readings, or voltage readings measured by devices integrated in EV chargers or separate from them. Additionally, the EV charging site may collect data indicative of benefits to site users. These may include proximities to points of interest, priorities of user vehicles in charging queues, safety concerns, degrees of difficulty of performing services such as unloading cargo, and times of decreased vehicle traffic. The data may also include user permissions within the charging site, which may prompt the charging site to confer benefits including priority in scheduling or faster charging.

In a second operation 420, the computing devices at the EV charging site or sites predict electrical load demands and generation at different locations within the one or more EV charging sites. The computing devices may predict the demands using machine learning or artificial intelligence. For example, the computing devices may implement a machine learning algorithm, such as a long short-term network (LSTM) on time-series charging data. By detecting patterns in the time-series data, the machine learning algorithm may be able to predict electric vehicle charging usage at different points during a day, week, month, or year. Identifying demands at these different times may enable a site operator or automatic process to provision electric power to loads based on a usage schedule created from these machine-learned predictions. Voltage and current waveform quality and shape may also be used to estimate, measure, or otherwise understand the characteristics of the load and utility condition. In an overload, altered, or otherwise suboptimal state, the utility waveform may be of different quality. The BESS systems and onsite power distribution may, through active control of voltage or current waveforms, enhance the operation of the grid or the load, whichever is scheduled within the controller.

In a third operation 430, the computing devices can direct EV charging stations and battery energy storage systems to provide needed power to the electrical loads, based on the predicted demands. The computing devices may be connected or communicatively coupled to EV charging site resources (including switchboards, panelboards, EV charging stations, bus bars, battery energy storage systems, and over current devices) remotely or physically via a network, such as a serial, LAN, WAN, or MESH network. The computing devices may provide instructions from site operators (e.g., CNOs) or from one or more computer programs to the site electrical components (e.g., panelboards and switchboards). The site electrical components may distribute allowed amounts of power, based on the instructions provided by the computing devices over the network, to the circuits they control. For example, a panelboard may provide a larger amount of power to a circuit comprising a group of chargers in one area of the EV charging site than another.

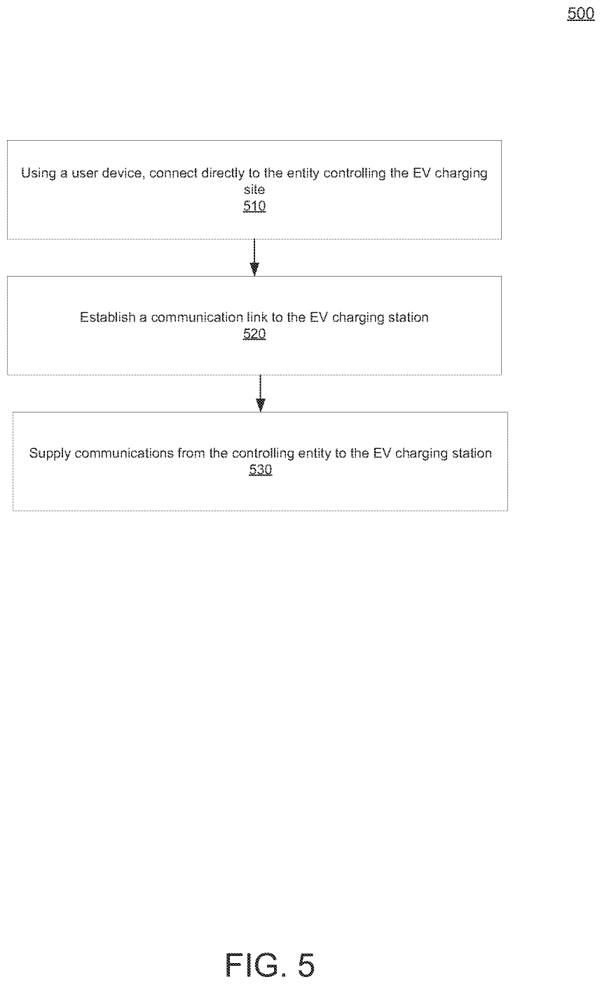

FIG. 5 is a flow chart of a process 500 for handling communications between an EV charging station and a backend server (e.g., one or more computing devices communicatively coupled to the EV charging site) in an event of communication failure, according to some embodiments of the present disclosure. The disclosed communication method may apply when an entity requiring communications to the site (e.g., a CPO, corporate group, or other entity controlling the site, hereafter referred to as a “controlling entity”) loses communications with an EV charging station or battery energy storage system . . .

The EV charging site may establish a link between nearby EV charging stations. The link may be a Wi-Fi link, a WAN, GPRS, wireless or wired communications means, or a MESH network, or any network enabling the chargers and other site components to communicate with one another. Additionally, the EV charging site may establish a link to a controller or other entity (e.g., a NOC or CPO) to commercial wireless networks. In some cases, the EV charging site may lose its connection to the backend server or controller. The process 500 may be used to address such an issue.

In a first operation 510, a user device or the user's electric vehicle directly connects to the entity controlling the EV charging site. The user may have attempted to charge the electric vehicle, and may have found that the EV charging station was not able to connect to the backend servers (accessed through the controlling entity) and was not able to supply power as a result, even if the user device could still communicate with the EV charging station itself. Direct connection to the controlling entity may be performed using software installed on the user device, where the software may contain licensing or permissions to enable such a connection. The EV charging site may require users to install such software on their devices prior to charging their EVs at the site. The connection between the user device and the controlling entity may be a Bluetooth connection, a Wi-Fi connection, an Ethernet or other wired connection, a Zigbee connection, a radio connection, or another type of connection or combination of connections, including one-way connections and enabling signals such as RFID.

In a second operation 520, the controlling entity establishes a communication link to the EV charging station using the user device or electric vehicle. Because the user device is able to connect separately to both the EV charging station and the controlling entity, it may act according to operation 530 as an intermediary to supply communications from the controlling entity to the EV charging station itself. When this connection is established, the EV charging station may supply power to the EV charging station, pursuant to the instructions from or EV charging station configuration imposed by the controlling entity.

According to another process, the EV charging site may also implement a fail-over communications system if communications between an electric vehicle and its associated EV charging station drop. The controller may first direct the EV charging station to attempt communication with the car by cycling commands. These commands may restart or initialize programs, functions, or routines associated with providing charge to vehicles. If this is not effective, the controller may cycle communications power to the interface board or control contactor. This may reset a communication link between the electric vehicle and charger. If this still fails, the controller may reboot the EV charging station. If this fails, the site controller may cause the power on the EV charger to be cycled remotely. Additionally, the site's controllers may locally buffer data sent to the EV charging stations in order to permit the chargers to operate even when future communications are dropped. Site controllers may accept and store new command sets to use in the event communications are dropped.

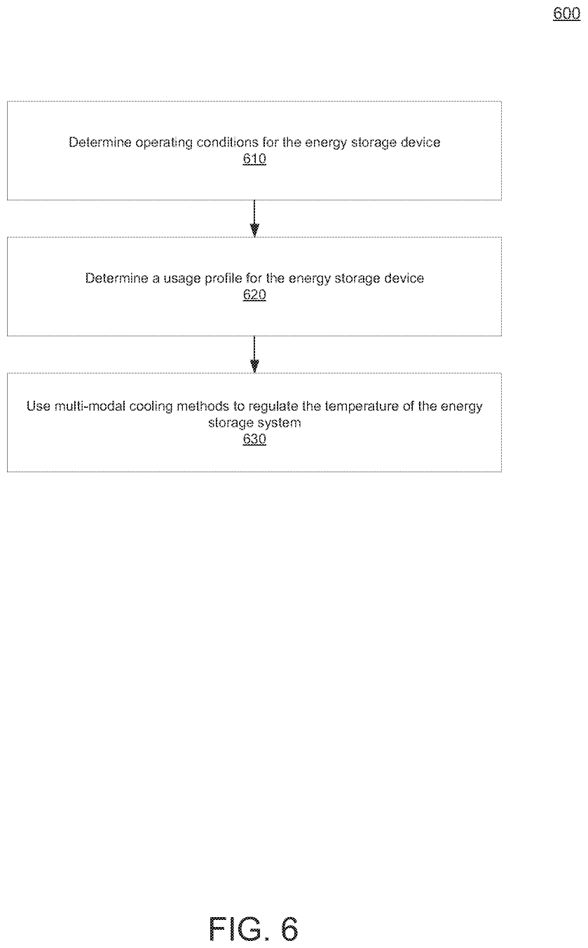

FIG. 6 is a flow chart of a process 600 for adaptively cooling a battery energy storage system (BESS) by performing machine learning analysis on data collected from the battery energy storage system and the EV charging site, according to some embodiments of the present disclosure. The adaptive method disclosed herein may improve battery life while reducing usage of HVAC systems. The data may relate to scheduled and predicted battery energy storage system usage, actual usage, weather, information collected from sensors (e.g., temperature, current draw, and voltage draw), and other local conditions (e.g., the occupancy of the site). Other examples of control aspects include information from external elements such as nearby event scheduling, transportation schedules, day of the week/holidays, and time of the year. Operating a battery energy storage system at different temperatures, according to characteristics of the battery energy storage system as well as external factors (running its battery cooler during warmer months or periods of heavy usage, for example), may extend the battery's useful life, may allow higher discharge rates, may allow more efficient charging or discharging, or have some other desired effect on the battery and site operation

In a first operation 610, the EV charging site determines operating conditions for the battery energy storage system. The EV charging site may also perform testing of a battery energy storage system to determine preferred operating conditions. The site may also use a machine learning algorithm to analyze data collected about the BESS to determine preferred operating conditions. The information may include the type of BESS, the thermal mass of the BESS, the types of loads to which the BESS supplies power, modes of operation of the BESS, duration of operation of the BESS, the impedance of the BESS, the time variance of the impedance of the BESS, the stage of life of the BESS (e.g., early, middle, late stage), the internal temperature of the battery, the power demand likely to be fulfilled using the BESS, a level of degradation of the BESS, site conditions (e.g., weather, air quality, HVAC runtime frequencies of natural disasters), and other information. The site may perform a calibration routine, which may include one or more machine learning algorithms, to analyze the collected data in order to determine the baseline operating conditions for use of the battery. The calibration routine may also comprise manual steps selected by site operators to test the battery.

In a second operation 620, the EV charging site determines a usage profile for the battery energy storage system based on the retrieved information about the battery energy storage system and the electric vehicle charging site. The usage profile may predict, for a particular time period, power demand from the battery energy storage system. The usage profile may include peaks indicating at what points in time the largest amounts of power are drawn from the battery energy storage system. At these points in time, the battery energy storage system may be in the most danger of overheating. In addition to peak temperatures, the usage profile may also incorporate average and lifetime average temperatures coincident with usage.

In a third operation 630, using the operating conditions and usage profile, the site uses multi-modal cooling methods to regulate the temperature of the energy storage system. The multi-modal cooling methods may include air cooling, air exchanger cooling, heat pipe, R134, freon compressor, compressor-less cooling, and economizer cooling. The site may provide more cooling during periods of heavy usage or other periods when the BESS is likely to have an elevated temperature (e.g., during periods of hot weather). The EV charging site may also delay activation of HVAC when power draw (and therefore usage) is expected to taper or decline or stop using HVAC when the BESS is not operational. The site may additionally use variable speed cooling systems to cool BESSes, with operating speed determined by the time constant of the BESS, thermal mass of the battery, and expected operational excursion.

The EV charging site may use a machine learning algorithm to determine which elements of the operating conditions and the usage profile contribute most to heating of the battery energy storage site at particular times and predict a preferred amount of cooling for a particular time period. The EV charging site may also use machine learning to predict which method of cooling may be most suitable (e.g., a method that may have a more rapid onset and may be able to cool down the battery more quickly), or may predict which cooling methods of the combination may be the most effective when combined.

In one example, a short-term discharge during a period of grid congestion may indicate a moderate load on a battery. The EV charging site can predict the storage battery temperature will rise to a particular level but will still fall below the activation temperature of the HVAC operating at full speed. The variable speed cooling system may allow the temperature of the cabinet enclosing the battery to rise above a nominal value but still remain within operational limits. The charge may complete, and the HVAC system may continuously operate at a low speed, thereby avoiding excess energy consumption and avoidance of demand charges.

In a second example, the EV charging site may use an HVAC system less able to tolerate sustained high temperatures during heavy usage. In this case, the site may leverage the thermal mass of the batteries to offset thermal rise within the cabinet during periods of heavy usage. The HVAC may then be run at maximum speeds for longer periods, increasing time spent at lower internal ambient temperatures and/or increasing the time the batteries are spent at a lower average temperature.

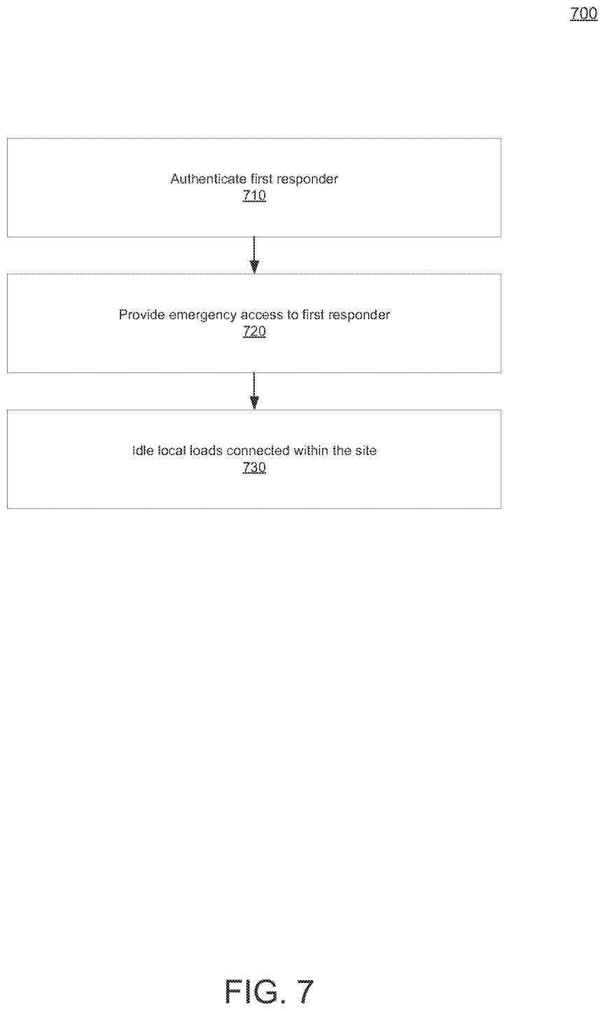

FIG. 7 is a flow chart of a process for providing emergency power from a charger to a vehicle of a first responder. First responders may need access to site power for multiple reasons (e.g., charging an emergency vehicle, communications, for powering a control hub). Additionally, first responders may need rapid access to charging, and may thus need to bypass payment and other operations of the EV charging station.

In a first operation 710, the EV charging site authenticates the first responder. Authentication may be performed by RFID token or tag, Knox or other similar secure box, key access, using a security code, cameras, audio commands, physical gestures, or a combination of these methods.

In a second operation 720, the EV charging site provides the emergency responder with access to at least one of the following functions: access to power during a power outage or when power demand causes the power provided by the site to be near the design limit, override of a function asking for payment from the first responder, and override of a predetermined cost for supplying power. The site may verify that the override was proper by initiating a communication (e.g., via a cell network) with a device of a local emergency responder or organization. Local emergency management services (EMS) may be granted permission to control rates of charging by EV charging stations at the site.

In a third operation 730, the EV charging site may idle other non-emergency local loads in order to ensure that the emergency vehicle has resources to charge. For example, the site may shut down a building HVAC system in order to enable higher output by a battery energy storage system, for rapid charging. Additionally, the site may halt the flow of charge to non-emergency vehicles. An automated system may decide which loads to stop supplying power to. Supervisory Control and Data Acquisition (SCADA) systems may direct the idling of loads, for example, by breaking circuits associated with non-emergency loads. The controller may meter energy flow from the EV charging stations. Instead of idling non-emergency loads, the site may reduce the flow of power to them. A local official may determine one or more limits for power distribution to non-emergency loads or the limit may be determined algorithmically. For example, a computer program or routine may calculate a maximum power level for each non-emergency load to enable the emergency vehicle to be charged. The EV charging site may continuously monitor connected loads and adjust this maximum amount when it determines the emergency load is not able to receive enough power.

The EV charging site may enable the emergency responder to override the payment protocol for the EV charging station in an emergency event. This may include bypassing payment entirely or paying using an emergency responder account. When active in this emergency dispersal mode, the controlled charging station may be synchronized with others within the network so as to coordinate appropriate charge levels.

The EV charging site may use its network to broadcast emergency messages within the site itself or to other sites. The site may communicate through its network with emergency personnel and different emergency organizations, to enable itself to be used as a hub or to coordinate emergency services. The EV charging site may post information for use by emergency personnel, such as information regarding device availability, charge capacity, site utilization, and other information.

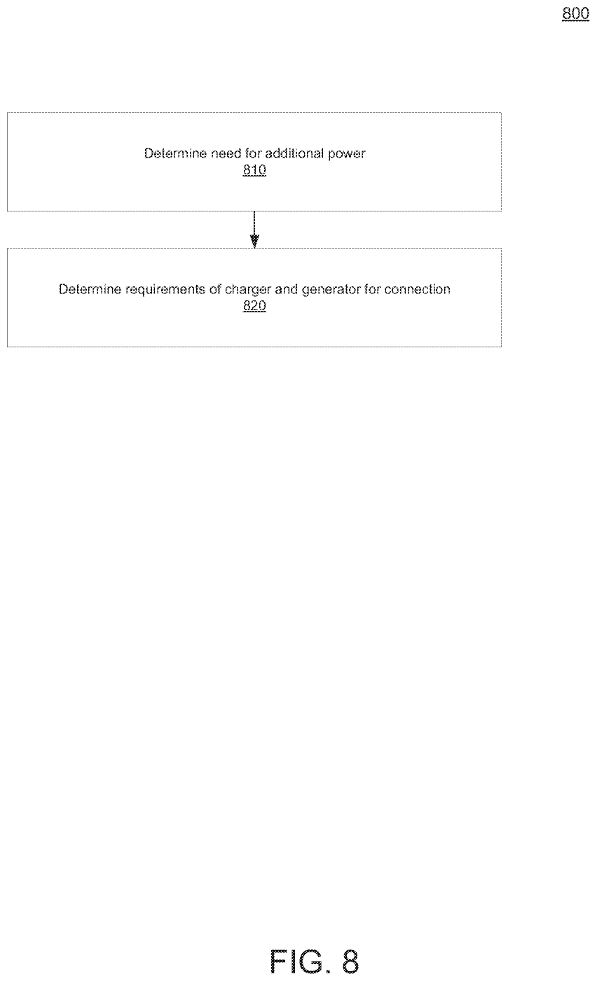

FIG. 8 illustrates a process flow diagram 800 for connecting to emergency infrastructure in an event additional power is needed. This may occur during adverse conditions (e.g., during a grid outage). The emergency infrastructure may enable the controller to supply momentary surges in demand for power. In a first operation 810, a local or remote controller for the EV charging site determines whether additional power (or energy) is needed to supply power to an emergency vehicle in an emergency situation. This may occur, for example, if the grid power supplied is already near the design limit, if a utility commanded grid curtailment/brownout or blackout for the site and/or the battery energy storage systems are not available (either because of command, brownout, or lack of stored energy in the batteries) to provide supplemental power to the emergency vehicle. The EV charging site may authenticate the electric vehicle attempting to charge to determine whether the electric vehicle's user is an emergency responder. If the user is an emergency responder and if additional emergency power is needed, the site may provide an emergency generator.

In a second operation 820, the EV charging site may determine the requirements of both the energy storage system and of the emergency power generator. The requirements may include connection interface requirements, power requirements, current requirements, temperature requirements, usage requirements, or other requirements. The controller may incorporate sizing for the generator in order to enable the generator to provide sufficient power without being overloaded. In the case of a combustion or other fuel supplied generator, the BESS and local controller may act to limit the amount of fuel consumed by dispatching the BESS, solar photovoltaic (PV), or other parallel connected devices. The controller may also provide specific permissions (e.g., for emergency personnel) to enable the generator to perform targeted charging or give priority to specific vehicles. If the BESS and emergency power generator are not compatible, the site may provide components to facilitate connection between the two (e.g., adapter cables, stepdown converters, transformers, or connector heads). The site controller may also instruct operator personnel with respect to how to properly connect the generator to the battery energy storage system. The generator may additionally be configured to interface directly with a battery energy storage system. The generator and battery energy storage system may also be operated so that neither one operates when the other is on, and components may be provided to manually, automatically, or autonomously connect and disconnect the BESSes and the generator(s) from the power distribution system so that each can work independently as and when required.

During adverse conditions, a battery energy storage system may backfeed a local power circuit onsite to power a connected asset (e.g., a building or lighting system). Backfeeding may be performed by islanding. An energy storage system may include an islanding signal that may indicate islanding a site component, such as an EV charging station, is possible. During a site outage, the battery energy storage system may power the connected component. The battery energy storage system may also be connected to an external islanding system (e.g., a backup generator, other loads via a small microgrid), to enable it to supply power while the EV charging site is non-operational. An external islanding system may be a microgrid (e.g., office building, factory, etc.) that contains one or more power sources (i.e., generator, storage, etc.)

A battery energy storage system may be equipped with a local generator connection point, permitting a genset to be safely, rapidly, and quickly connected to the energy storage system load, (such as electric vehicle charging or local energy storage system peak plant application).

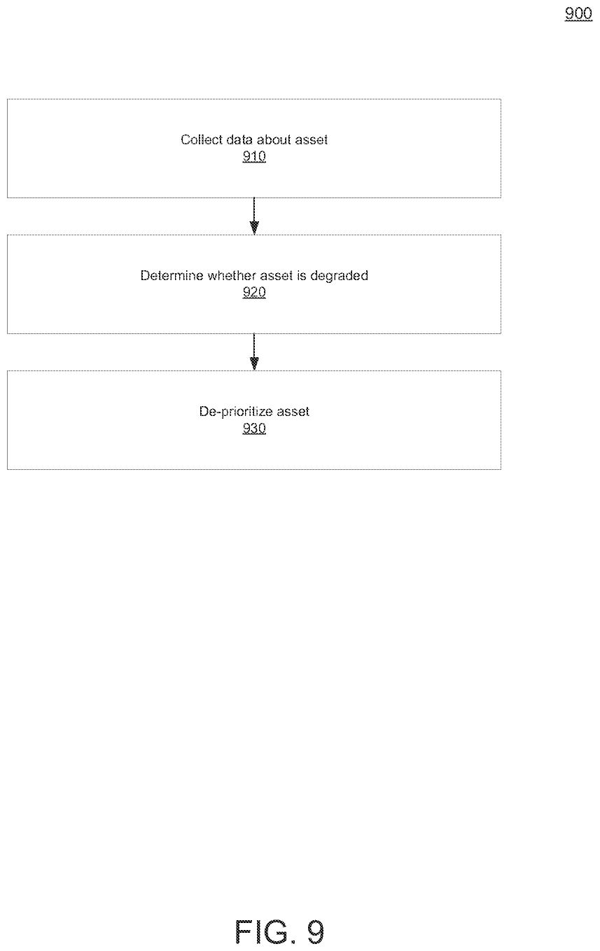

FIG. 9 is a flow chart of a process 900 for de-provisioning degraded EV charging site assets, according to some embodiments of the present disclosure. In a first operation 910, the EV charging site collects data regarding assets within the site (e.g., EV charging stations, feeder lines, panelboards, switchboards, signaling devices, and other electronic equipment). The data collected may include current levels, voltage levels, power levels, harmonic measurements, temperatures exceeding specified thresholds, physical conditions of electrical components (e.g., wires, switches, and fuses), usage history and usage patterns for the assets, and other data.

In a second operation 920, the EV charging site determines whether the asset has been degraded. Determination may be performed manually by site operators analyzing collected metrics and comparing them to thresholds. Additionally or alternatively, the determination may be performed using a machine learning algorithm. For example, the machine learning algorithm may be trained to predict whether an asset is degraded by performing analysis on features of the asset. Particular values for particular features may be indicative of degradation. The machine learning algorithm may make a binary prediction as to whether the asset is degraded or may make a prediction indicating a degree of degradation. The site may perform analysis periodically, such as hourly, daily, weekly, or monthly, to determine on a regular basis which assets may be degrading. So as to accelerate the machine learning algorithm, the system may be programmed with both adverse and optimized parameters to accelerate the learning process. In the case of several similar systems connected, a data sharing model may be employed between the sites, sharing initial setpoints, operational parameters, and other settable parameters normally set by an automated means.

In a third operation 930, the site de-prioritizes or deprovisions the asset if the asset shows sufficient signs of degradation. The system may create a ranked list of assets and assign highest priorities to those that are the least degraded. Or, if most or all assets show some level of degradation, the site may prioritize assets which may be replaced or brought to working operation most quickly.

### Machine Learning

The methods described herein can comprise computer-implemented methods of supervised or unsupervised learning methods, including support vector machines (SVM), random forests, clustering algorithm (or software module), gradient boosting, logistic regression, and/or decision trees. The machine learning methods as described herein can improve power provisioning as described herein. Machine learning may be used to train a classifier or predictor described herein, for example in training a classifier or predictor to provide improved power provisioning.

Supervised learning algorithms can be algorithms that rely on the use of a set of labeled, paired training data examples to infer the relationship between an input data and output data. Unsupervised learning algorithms can be algorithms used to draw inferences from training data sets to output data. Unsupervised learning algorithms can comprise cluster analysis, which can be used for exploratory data analysis to find hidden patterns or groupings in process data. One example of an unsupervised learning method can comprise principal component analysis. Principal component analysis can comprise reducing the dimensionality of one or more variables. The dimensionality of a given variables can be at least 1, 5, 10, 50, 100, 200, 300, 400, 500, 600, 700, 800, 900, 1000, 1100, 1200 1300, 1400, 1500, 1600, 1700, 1800, or greater. The dimensionality of a given variables can be 1800 or less, 1600 or less, 1500 or less, 1400 or less, 1300 or less, 1200 or less, 1100 or less, 1000 or less, 900 or less, 800 or less, 700 or less, 600 or less, 500 or less, 400 or less, 300 or less, 200 or less, 100 or less, 50 or less, or 10 or less.

The computer-implemented methods can comprise statistical techniques. In some embodiments, statistical techniques can comprise linear regression, classification, resampling methods, subset selection, shrinkage, dimension reduction, nonlinear models, tree-based methods, support vector machines, unsupervised learning, or any combination thereof.

A linear regression can be a method to predict a target variable by fitting a best linear relationship between a dependent and independent variable. The best fit can mean that the sum of all distances between a shape and actual observations at each point is the least. Linear regression can comprise simple linear regression and multiple linear regression. A simple linear regression can use a single independent variable to predict a dependent variable. A multiple linear regression can use more than one independent variable to predict a dependent variable by fitting a best linear relationship.

A classification can be a data mining technique that assigns categories to a collection of data in order to achieve accurate predictions and analysis. Classification techniques can comprise logistic regression and discriminant analysis. Logistic regression can be used when a dependent variable is dichotomous (binary). Logistic regression can be used to discover and describe a relationship between one dependent binary variable and one or more nominal, ordinal, interval or ratio-level independent variables. A resampling can be a method comprising drawing repeated samples from original data samples. A resampling may not involve a utilization of a generic distribution tables in order to compute approximate probability values. A resampling can generate a unique sampling distribution on a basis of an actual data. In some embodiments, a resampling can use experimental methods, rather than analytical methods, to generate a unique sampling distribution. Resampling techniques can comprise bootstrapping and cross-validation. Bootstrapping can be performed by sampling with replacement from original data and take “not chosen” data points as test cases. Cross validation can be performed by split training data into a plurality of parts.

A subset selection can identify a subset of predictors related to a response. A subset selection can comprise a best-subset selection, forward stepwise selection, backward stepwise selection, hybrid method, or any combination thereof. In some instances, shrinkage fits a model involving all predictors, but estimated coefficients are shrunken towards zero relative to the least squares estimates. This shrinkage can reduce variance. A shrinkage can comprise ridge regression and a lasso. A dimension reduction can reduce a problem of estimating n+1 coefficients to a simpler problem of m+1 coefficients, where m<n. It can be attained by computing n different linear combinations, or projections, of variables. Then these n projections are used as predictors to fit a linear regression model by least squares. Dimensionality reduction can comprise principal component regression and partial least squares. A principal component regression can be used to derive a low dimensional set of features from a large set of variables. A principal component used in a principal component regression can capture a large amount of variance in data using linear combinations of data in subsequently orthogonal directions. The partial least squares can be a supervised alternative to principal component regression because partial least squares can make use of a response variable to identify new features.

A nonlinear regression can be a form of regression analysis in which observational data are modeled by a function which is a nonlinear combination of model parameters and depends on one or more independent variables. A nonlinear regression can comprise a step function, piecewise function, spline, generalized additive model, or any combination thereof.

Tree-based methods can be used for both regression and classification problems. Regression and classification problems can involve stratifying or segmenting the predictor space into a number of simple regions. Tree-based methods can comprise bagging, boosting, random forest, or any combination thereof. Bagging can decrease a variance of prediction by generating additional data for training from the original dataset using combinations with repetitions to produce multistep of the same carnality/size as original data. Boosting can calculate an output using several different models and then average a result using a weighted average approach. A random forest algorithm can draw random bootstrap samples of a training set. Support vector machines can be classification techniques. Support vector machines can comprise finding a hyperplane that best separates two classes of points with the maximum margin. Support vector machines can constrain an optimization problem such that a margin is maximized subject to a constraint that it perfectly classifies data.

Unsupervised methods can be methods to draw inferences from datasets comprising input data without labeled responses. Unsupervised methods can comprise clustering, principal component analysis, k-Mean clustering, hierarchical clustering, or any combination thereof.

### Training

A machine learning system as described herein is configured to undergo at least one training phase wherein the machine learning system is trained to carry out one or more tasks including data extraction, data analysis, and generation of output.

In some embodiments of the system, a system component is configured to provide training data, comprising, for example, EV charging data, in a training set. In some embodiments, the system utilizes automatic statistical analysis of data to determine which features to extract and/or analyze from the set of EV charging data. In some of these embodiments, the machine learning software module determines which features to extract and/or analyze from a set of EV charging data based on the training of the machine learning system.

In some embodiments, a machine learning software module is trained using a data set and a target in a manner that might be described as supervised learning. In these embodiments, the data set is conventionally divided into a training set and a test set and/or a validation set. A target is specified that contains the correct classification of each input value (e.g., high or low expression) in the data set. For example, a set of EV charging data is repeatedly presented to the machine learning software module, and for each sample presented during training, the output generated by the machine learning software module is compared with the desired target. The difference between the target and the set of input samples is calculated, and the machine learning system is modified to cause the output to more closely approximate the desired target value. In some embodiments, a back-propagation algorithm is utilized to cause the output to more closely approximate the desired target value. After a large number of training iterations, the machine learning software module output will closely match the desired target for each sample in the input training set. Subsequently, when new input data, not used during training, is presented to the machine learning software module, it may generate an output classification value indicating which of the categories the new sample is most likely to fall into. The machine learning software module is said to be able to “generalize” from its training to new, previously unseen input samples. This feature of a machine learning software module allows it to be used to classify almost any input data which has a mathematically formulatable relationship to the category to which it should be assigned.

In some embodiments of the machine training software module described herein, the machine training software module utilizes a global training model. A global training model is based on the machine training software module having trained on data from many different EVs and thus, a machine training system that utilizes a global training model is configured to be used to determine billing rates, set costs, or provision power or charging resources.

In some embodiments of the machine training software module described herein, the machine training software module utilizes a simulated training model. A simulated training model is based on the machine training software module having trained on data from simulated EV charging data.

In some embodiments, the use of training models changes as the availability of EV charging data. For instance, a simulated training model may be used if there are insufficient quantities of appropriate EV charging data available for training the machine training software module to a desired accuracy. This may be particularly true in the early days of implementation, as a sparse amount of EV charging data may be available initially. As additional data becomes available, the training model can change to a global model. In some embodiments, a mixture of training models may be used to train the machine training software module. For example, a simulated and global training model may be used, utilizing a mixture of real EV data and simulated data to meet training data requirements.

Unsupervised learning is used, in some embodiments, to train a machine training software module to use input data such as, for example, amino acid sequence data and output, for example, a prediction of protein expressivity. Unsupervised learning, in some embodiments, includes feature extraction which is performed by the machine learning software module on the input data. Extracted features may be used for visualization, for classification, for subsequent supervised training, and more generally for representing the input for subsequent storage or analysis.

Machine learning software modules that are commonly used for unsupervised training include k-means clustering, mixtures of multinomial distributions, affinity propagation, discrete factor analysis, hidden Markov models, Boltzmann machines, restricted Boltzmann machines, autoencoders, convolutional autoencoders, recurrent neural network autoencoders, and long short-term memory (LSTM) autoencoders. While there are many unsupervised learning models, they all have in common that, for training, they require a training set consisting of input charging data, without associated labels.

Data that is inputted into the machine learning system may be used, in some embodiments, to construct a hypothesis function to determine optimal power provisioning. In some embodiments, a machine learning system is configured to determine if the outcome of the hypothesis function was achieved and based on that analysis determine with respect to the data upon which the hypothesis function was constructed. That is, the outcome tends to either reinforce the hypothesis function with respect to the data upon which the hypothesis function was constructed or contradict the hypothesis function with respect to the data upon which the hypothesis function was constructed. In these embodiments, depending on how close the outcome tends to be to an outcome determined by the hypothesis function, the machine learning algorithm will either adopt, adjust, or abandon the hypothesis function with respect to the data upon which the hypothesis function was constructed. As such, the machine learning algorithm described herein dynamically learns through the training phase what characteristics of an input (e.g., data) are most predictive in determining an optimal level of power provisioning.

For example, a machine learning software module is provided with data on which to train so that it, for example, can determine the most salient features of EV charging data to operate on. The machine learning software modules described herein train as to how to analyze the charging data, rather than analyzing the charging data using pre-defined instructions. As such, the machine learning software modules described herein dynamically learn through training what characteristics of an input signal are most predictive in determining optimal power provisioning or quantities associated with power provisioning.

In some embodiments, training begins when the machine learning system is given EV charging data and asked to determine a level of power provisioning or a derived quantity thereof. The predicted level of power provisioning or derived quantity thereof may then be compared to a true optimal level of power provisioning for a particular facility or site. An optimization technique such as gradient descent and backpropagation is used to update the weights in each layer of the machine learning software module to produce closer agreement between the outputs predicted by the machine learning software module, and the actual level of expression. This process is repeated with new charging data until the accuracy of the network has reached the desired level. Following training with the appropriate EV charging data given above, the machine learning module is able to analyze the EV charging data and determine a level of power provisioning or derived quantity thereof.

In general, a machine learning algorithm is trained using a large set of EV charging data or and/or any features or metrics computed from the above said data with the corresponding ground-truth values. The training phase constructs a transformation function for predicting an optimal level of power provision by using the EV charging data and/or any features or metrics computed from the above said data of a particular EV charging station. The machine learning algorithm dynamically learns through training what characteristics of the input are most predictive of determining an optimal level of power provisioning or derived quantity thereof. A prediction phase uses the constructed and optimized transformation function from the training phase to predict the optimal level of power provisioning or derived quantity thereof.

### Prediction Phase

Following training, the machine learning algorithm is used to determine, for example, a predicted optimal level of power provisioning or derived quantity thereof on which the system was trained using the prediction phase. With appropriate training data, the system can identify an optimal level of power provisioning or derived quantity thereof.

The prediction phase uses the constructed and optimized hypothesis function from the training phase to predict the optimal level of power provisioning or derived quantity thereof.

In some embodiments, a probability threshold is used to tune the sensitivity of the trained network. For example, the probability threshold can be 1%, 2%, 5%, 10%, 15%, 20%, 25%, 30%, 35%, 40%, 45%, 50%, 55%, 60%, 65%, 70%, 75%, 80%, 85%, 90%, 95%, 98% or 99%. In some embodiments, the probability threshold is adjusted if the accuracy falls below a predefined adjustment threshold. In some embodiments, the adjustment threshold is used to determine the parameters of the training period. For example, if the accuracy of the probability threshold falls below the adjustment threshold, the system can extend the training period and/or require additional EV charging data. In some embodiments, additional EV charging data samples are included in the training data. In some embodiments, additional EV charging data samples can be used to refine the training data set.

### Computer Systems

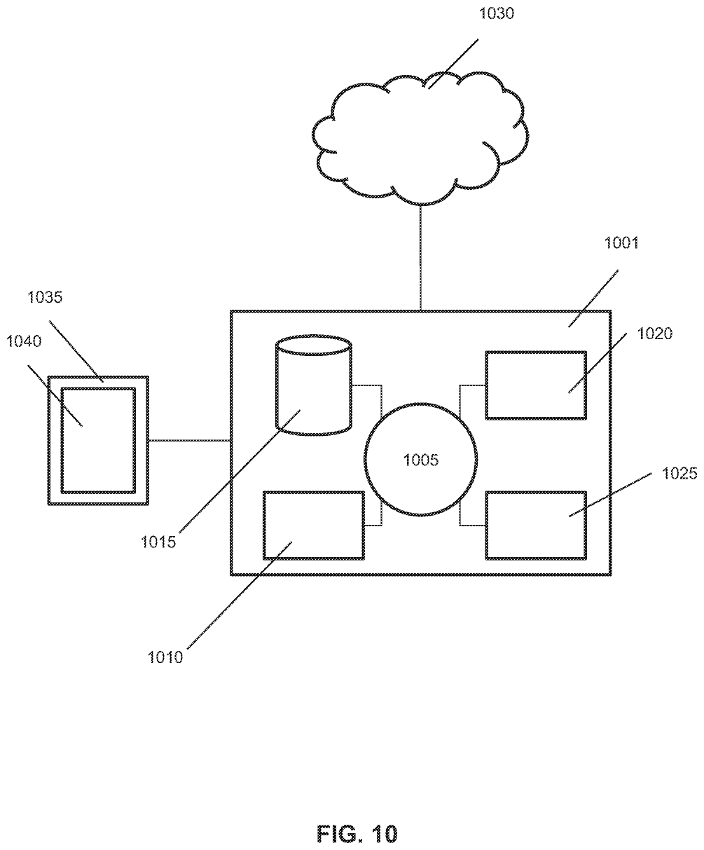

The present disclosure provides computer systems that are programmed to implement methods of the disclosure. FIG. 10 shows a computer system 1001 that is programmed or otherwise configured to provisioning electric power to electric vehicles. The computer system 1001 can regulate various aspects of artificial intelligence processing of the present disclosure, such as, for example, determining adaptive heating and cooling. The computer system 1001 can be an electronic device of a user or a computer system that is remotely located with respect to the electronic device. The electronic device can be a mobile electronic device.

The computer system 1001 includes a central processing unit (CPU, also “processor” and “computer processor” herein) 1005, which can be a single core or multi core processor, or a plurality of processors for parallel processing. The computer system 1001 also includes memory or memory location 1010 (e.g., random-access memory, read-only memory, flash memory), electronic storage unit 1015 (e.g., hard disk), communication interface 1020 (e.g., network adapter) for communicating with one or more other systems, and peripheral devices 1025, such as cache, other memory, data storage and/or electronic display adapters. The memory 1010, storage unit 1015, interface 1020 and peripheral devices 1025 are in communication with the CPU 1005 through a communication bus (solid lines), such as a motherboard. The storage unit 1015 can be a data storage unit (or data repository) for storing data. The computer system 1001 can be operatively coupled to a computer network (“network”) 1030 with the aid of the communication interface 1020. The network 1030 can be the Internet, an internet and/or extranet, or an intranet and/or extranet that is in communication with the Internet. The network 1030 in some cases is a telecommunication and/or data network. The network 1030 can include one or more computer servers, which can enable distributed computing, such as cloud computing. The network 1030, in some cases with the aid of the computer system 1001, can implement a peer-to-peer network, which may enable devices coupled to the computer system 1001 to behave as a client or a server.

The CPU 1005 can execute a sequence of machine-readable instructions, which can be embodied in a program or software. The instructions may be stored in a memory location, such as the memory 1010. The instructions can be directed to the CPU 1005, which can subsequently program or otherwise configure the CPU 1005 to implement methods of the present disclosure. Examples of operations performed by the CPU 1005 can include fetch, decode, execute, and writeback.

The CPU 1005 can be part of a circuit, such as an integrated circuit. One or more other components of the system 1001 can be included in the circuit. In some cases, the circuit is an application specific integrated circuit (ASIC).

The storage unit 1015 can store files, such as drivers, libraries and saved programs. The storage unit 1015 can store user data, e.g., user preferences and user programs. The computer system 1001 in some cases can include one or more additional data storage units that are external to the computer system 1001, such as located on a remote server that is in communication with the computer system 1001 through an intranet or the Internet.

The computer system 1001 can communicate with one or more remote computer systems through the network 1030. For instance, the computer system 1001 can communicate with a remote computer system of a user (e.g., a server for performing machine learning calculations). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1001 via the network 1030.

Methods as described herein can be implemented by way of machine (e.g., computer processor) executable code stored on an electronic storage location of the computer system 1001, such as, for example, on the memory 1010 or electronic storage unit 1015. The machine executable or machine-readable code can be provided in the form of software. During use, the code can be executed by the processor 1005. In some cases, the code can be retrieved from the storage unit 1015 and stored on the memory 1010 for ready access by the processor 1005. In some situations, the electronic storage unit 1015 can be precluded, and machine-executable instructions are stored on memory 1010.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 1001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1001 can include or be in communication with an electronic display 1035 that comprises a user interface (UI) 1040 for providing, for example, methods for changing charging costs to vehicles. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1005. The algorithm can, for example, determine a usage profile for a battery energy storage system.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1-47. (canceled)

48. A method for power distribution at an electric (EV) charging site, wherein the EV charging site comprises a plurality of energy storage systems interspersed with a plurality of EV charging stations, wherein the EV charging stations and the energy storage systems are connected to a grid or other electrical power source by a plurality of electrical feeders, the method comprising:
for an electrical feeder of the plurality of electrical feeders, monitoring a current flow at one or more points of connection of the electrical feeder to an electrical load of the plurality of electrical loads;
if the current is above a design limit, stopping a flow of current to the electrical load and providing current from an energy storage system; and
if the current is below the design limit, maintaining the flow of current to the electrical load and charging one or more of the plurality of energy storage systems.

49. The method of claim 48, wherein stopping the flow of current to the electrical load comprises sending a signal to a breaker.

50. The method of claim 48, wherein the energy storage system is a battery energy storage system.

51. The method of claim 48, wherein maintaining the flow of current comprises automatic reconfiguring of the current flow paths using a trained machine learning algorithm.

52. The method of claim 51, wherein the machine learning algorithm determines when to configure charging and discharging of the energy storage system.

53. The method of claim 52, wherein the monitoring the current flow is performed continuously.

54. The method of claim 52, wherein a point of connection of the one or more points of connection is next to a meter or next to a transformer.

55. The method of claim 48, further comprising connecting one or more additional energy storage systems when one or more requirements of the plurality of electrical loads changes.

56. The method of claim 48, wherein the plurality of energy storage systems is connected using a mesh network.

57. The method of claim 48, wherein the plurality of energy storage systems is controllable as a single unit.

58. The method of claim 48, wherein the plurality of energy storage systems includes one or more energy storage systems that are individually controllable.

59. A method for selecting an EV charging station of a plurality of EV charging stations at an EV charging site, comprising:
obtaining one or more parameters of each of the plurality of electric vehicle charges, wherein the one or more parameters comprise one or more of an efficiency, a temperature, and a voltage drop;
computer processing the one or more parameters to determine a usage schedule for the plurality of electric vehicle chargers at the electric vehicle charging site; and
selecting an EV charging station for use by a user, based on the usage schedule.

60. The method of claim 59, further comprising indicating the selected EV charging station to the user.

61. The method of claim 60, wherein the indicating is provided using an onsite announcement or through an electronic display.

62. The method of claim 61, wherein the onsite announcement is visual or audible.

63. The method of claim 61, wherein the electronic display is a user device.

64. The method of claim 63, wherein the indicating is performed using a mobile application.

65. The method of claim 64, wherein the one or more parameters further comprise advertising information and user information obtained from the user device.

66. The method of claim 59, wherein determining the usage schedule further comprises computer processing degradation data, economic data, proximity data, or user data.

67. The method of claim 66, wherein the degradation data corresponds to or indicates a presence of elevated temperature, efficiency loss, or unexpected changes in fan speed, fan operation time, fan pressure, voltage, current draw, or energy delivered by an energy storage system.

68. The method of claim 66, wherein economic data is buying patterns, charging rates, or user purchase behavior.

69. The method of claim 66, wherein proximity data is closeness to retail entities, weather data, natural disaster data, or location safety data.

70. The method of claim 66, wherein user data is parking priority data, vehicle type, or vehicle use.

71. A method for performing predictive cooling of an energy storage unit, comprising:
implementing a calibration routine to determine a plurality of operating states of an energy storage system;
determining a usage profile of the energy storage system; and
initiating multimodal cooling of the energy storage system based on the calibration routine and the usage profile, wherein the multimodal cooling comprises at least two of air cooling, heat pipe cooling, and economizer cooling, based on the usage profile and the calibration routine.

72. A method for providing a user emergency access to an electric vehicle (EV) charging station, comprising:
(a) receiving a request from the user to access the EV charging station;
(b) determining that the request is valid;
(c) in response to (b), providing the user access to the EV charging station; and
(d) locally idling one or more loads, wherein the one or more loads are not a vehicle of the user.

73. A method for regulating a supply of power from one or more EV charging stations at an EV charging site, comprising:
obtaining data regarding demand for power at the EV charging site;
processing the data to determine changes in power supply for the one or more EV charging stations; and
prompting at least one of the one or more EV charging stations to perform an action, responsive to the changes in power supply, wherein the action comprises reducing a cost to charge the electric vehicle, increasing a cost to charge the electric vehicle, or providing an offer to a user of the electric vehicle.
